(19) United States
(12) Patent Application Publication
(10) Pub. No.: US 2026/0189343 A1
(43) Pub. Date: Jul. 2, 2026

(54) PERFORMING CHANNEL ESTIMATION IN FREQUENCY DIVISION DUPLEX SYSTEMS

(71) Applicant: QUALCOMM Incorporated, San Diego, CA (US)

(72) Inventors: Vasanthan RAGHAVAN, West Windsor Township, NJ (US); Xiaoxia ZHANG, San Diego, CA (US); Junyi LI, Greentown, PA (US)

(21) Appl. No.: 19/001,922

(22) Filed: Dec. 26, 2024

(51) Int. Cl. H04L 5/00; H04B 17/318; H04W 16/28

(52) U.S. Cl. CPC H04L 5/0051; H04B 17/318; H04W 16/28

(57) ABSTRACT

Methods, systems, and devices for wireless communications are described. Techniques described herein may enable a user equipment (UE) and a network entity communicating via a frequency division duplexing (FDD) configuration to implement reciprocity-based learning techniques to perform an estimation of a downlink channel based on measurements of the uplink channel, and vice versa. For example, the network entity may perform measurements of one or more uplink reference signals and may estimate a quantity of clusters and spatial characteristics associated with the uplink reference signals. The UE may perform measurements of one or more downlink reference signals and may estimate a gain and phase shift associated with the downlink reference signals. The UE may feedback the gain and phase shift to the network entity with varying periodicities, and the network entity may estimate the downlink channel based on the gain, phase shift, and spatial characteristics.

### FIELD OF TECHNOLOGY

The following relates to wireless communications, including techniques for performing channel estimation in frequency division duplex (FDD) systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, via an uplink channel between the UE and a network entity, one or more uplink reference signals at a first periodicity, the uplink channel associated with a first set of frequency resources, performing, for a first set of downlink reference signals received via a downlink channel between the UE and the network entity, a first set of measurements associated with a gain of the downlink channel, the downlink channel associated with a second set of frequency resources different from the first set of frequency resources, where the first set of downlink reference signals are received in accordance with a second periodicity that is less than the first periodicity, performing, for a second set of downlink reference signals received via the downlink channel, a second set of measurements associated with a phase shift of the downlink channel, where the second set of downlink reference signals are received in accordance with a third periodicity that is less than the second periodicity, transmitting one or more feedback messages indicating the gain associated and the phase shift associated with the downlink channel, and communicating one or more messages with the network entity via the downlink channel, the uplink channel, or both, using a set of downlink communication parameters, a set of uplink communication parameters, or both, that are based on the gain, the phase shift, or both.

A UE for wireless communications is described. The UE may include one or more memories storing processor executable code, and one or more processors coupled with the one or more memories. The one or more processors may individually or collectively be operable to execute the code to cause the UE to transmit, via an uplink channel between the UE and a network entity, one or more uplink reference signals at a first periodicity, the uplink channel associated with a first set of frequency resources, perform, for a first set of downlink reference signals received via a downlink channel between the UE and the network entity, a first set of measurements associated with a gain of the downlink channel, the downlink channel associated with a second set of frequency resources different from the first set of frequency resources, where the first set of downlink reference signals are received in accordance with a second periodicity that is less than the first periodicity, perform, for a second set of downlink reference signals received via the downlink channel, a second set of measurements associated with a phase shift of the downlink channel, where the second set of downlink reference signals are received in accordance with a third periodicity that is less than the second periodicity, transmit one or more feedback messages indicating the gain associated and the phase shift associated with the downlink channel, and communicate one or more messages with the network entity via the downlink channel, the uplink channel, or both, using a set of downlink communication parameters, a set of uplink communication parameters, or both, that are based on the gain, the phase shift, or both.

Another UE for wireless communications is described. The UE may include means for transmitting, via an uplink channel between the UE and a network entity, one or more uplink reference signals at a first periodicity, the uplink channel associated with a first set of frequency resources, means for performing, for a first set of downlink reference signals received via a downlink channel between the UE and the network entity, a first set of measurements associated with a gain of the downlink channel, the downlink channel associated with a second set of frequency resources different from the first set of frequency resources, where the first set of downlink reference signals are received in accordance with a second periodicity that is less than the first periodicity, means for performing, for a second set of downlink reference signals received via the downlink channel, a second set of measurements associated with a phase shift of the downlink channel, where the second set of downlink reference signals are received in accordance with a third periodicity that is less than the second periodicity, means for transmitting one or more feedback messages indicating the gain associated and the phase shift associated with the downlink channel, and means for communicating one or more messages with the network entity via the downlink channel, the uplink channel, or both, using a set of downlink communication parameters, a set of uplink communication parameters, or both, that are based on the gain, the phase shift, or both.

A non-transitory computer-readable medium storing code for wireless communications is described. The code may include instructions executable by one or more processors to transmit, via an uplink channel between the UE and a network entity, one or more uplink reference signals at a first periodicity, the uplink channel associated with a first set of frequency resources, perform, for a first set of downlink reference signals received via a downlink channel between the UE and the network entity, a first set of measurements associated with a gain of the downlink channel, the downlink channel associated with a second set of frequency resources different from the first set of frequency resources, where the first set of downlink reference signals are received in accordance with a second periodicity that is less than the first periodicity, perform, for a second set of downlink reference signals received via the downlink channel, a second set of measurements associated with a phase shift of the downlink channel, where the second set of downlink reference signals are received in accordance with a third periodicity that is less than the second periodicity, transmit one or more feedback messages indicating the gain associated and the phase shift associated with the downlink channel, and communicate one or more messages with the network entity via the downlink channel, the uplink channel, or both, using a set of downlink communication parameters, a set of uplink communication parameters, or both, that are based on the gain, the phase shift, or both.

In some examples of the method, UEs, and non-transitory computer-readable medium described herein, transmitting the one or more feedback messages may include operations, features, means, or instructions for transmitting a first set of feedback messages indicating the gain in accordance with the second periodicity and transmitting a second set of feedback messages indicating the phase shift in accordance with the third periodicity, where communicating the one or more messages may be based on transmitting the first set of feedback messages in accordance with the second periodicity and transmitting the second set of feedback messages in accordance with the third periodicity.

Some examples of the method, UEs, and non-transitory computer-readable medium described herein may further include operations, features, means, or instructions for receiving, from the network entity, control signaling indicating the set of downlink communication parameters associated with the downlink channel, the set of uplink communication parameters associated with the uplink channel, or both, based on transmitting the one or more feedback messages indicating the gain and the phase shift associated with the downlink channel.

In some examples of the method, UEs, and non-transitory computer-readable medium described herein, the set of downlink communication parameters, the set of uplink communication parameters, or both, includes a transmission power, a modulation and coding scheme (MCS), a precoder matrix, a rank, or any combination thereof.

Some examples of the method, UEs, and non-transitory computer-readable medium described herein may further include operations, features, means, or instructions for receiving a third set of downlink reference signals from the network entity via the downlink channel in accordance with a fourth periodicity that may be greater than the second periodicity and the third periodicity, performing a channel estimation of the downlink channel based on receiving the third set of downlink reference signals, and transmitting one or more additional feedback messages indicating the channel estimation of the downlink channel, where the set of downlink communication parameters, the set of uplink communication parameters, or both, may be based on the channel estimation of the downlink channel.

In some examples of the method, UEs, and non-transitory computer-readable medium described herein, the first periodicity, the second periodicity, the third periodicity, or any combination thereof, may be based on one or more spatial characteristics associated with the one or more uplink reference signals.

In some examples of the method, UEs, and non-transitory computer-readable medium described herein, the one or more spatial characteristics associated with the one or more uplink reference signals include an azimuth angle of arrival (AoA), a zenith angle of arrival (ZoA), an azimuth angle of departure (AoD), a zenith angle of departure (ZoD), or any combination thereof.

Some examples of the method, UEs, and non-transitory computer-readable medium described herein may further include operations, features, means, or instructions for receiving control signaling indicating a configuration of the first periodicity, the second periodicity, the third periodicity, or any combination thereof.

In some examples of the method, UEs, and non-transitory computer-readable medium described herein, a value of the second periodicity may be based on the gain associated with the downlink channel being within a threshold amount from a second gain associated with the uplink channel.

Some examples of the method, UEs, and non-transitory computer-readable medium described herein may further include operations, features, means, or instructions for obtaining a second gain and a second phase shift associated with the uplink channel based on the gain and the phase shift associated with the downlink channel.

In some examples of the method, UEs, and non-transitory computer-readable medium described herein, obtaining the second gain and the second phase shift may include operations, features, means, or instructions for identifying the second gain and the second phase shift based on a look-up table that associates gain values and phase shift values of the downlink channel with gain values and phase shift values of the uplink channel.

A method for wireless communications by a network entity is described. The method may include performing, for a set of uplink reference signals received from a UE via an uplink channel between the UE and the network entity, a set of measurements associated with one or more spatial characteristics of the set of uplink reference signals, the uplink channel associated with a first set of frequency resources, where the set of uplink reference signals are received in accordance with a first periodicity, outputting, via a downlink channel between the UE and the network entity, a first set of downlink reference signals at a second periodicity, the downlink channel associated with a second set of frequency resources different from the first set of frequency resources, where the first set of downlink reference signals are output in accordance with a second periodicity that is less than the first periodicity, outputting, via the downlink channel, a second set of downlink reference signals at a third periodicity that is less than the second periodicity, obtaining one or more feedback messages indicating a gain of the downlink channel that is based on the first set of downlink reference signals and a phase shift of the downlink channel that is based on the second set of downlink reference signals, and communicating one or more messages with the network entity via the downlink channel, the uplink channel, or both, using a set of downlink communication parameters, a set of uplink communication parameters, or both, that are based on the gain, the phase shift, or both.

A network entity for wireless communications is described. The network entity may include one or more memories storing processor executable code, and one or more processors coupled with the one or more memories. The one or more processors may individually or collectively be operable to execute the code to cause the network entity to perform, for a set of uplink reference signals received from a UE via an uplink channel between the UE and the network entity, a set of measurements associated with one or more spatial characteristics of the set of uplink reference signals, the uplink channel associated with a first set of frequency resources, where the set of uplink reference signals are received in accordance with a first periodicity, output, via a downlink channel between the UE and the network entity, a first set of downlink reference signals at a second periodicity, the downlink channel associated with a second set of frequency resources different from the first set of frequency resources, where the first set of downlink reference signals are output in accordance with a second periodicity that is less than the first periodicity, output, via the downlink channel, a second set of downlink reference signals at a third periodicity that is less than the second periodicity, obtain one or more feedback messages indicating a gain of the downlink channel that is based on the first set of downlink reference signals and a phase shift of the downlink channel that is based on the second set of downlink reference signals, and communicate one or more messages with the network entity via the downlink channel, the uplink channel, or both, using a set of downlink communication parameters, a set of uplink communication parameters, or both, that are based on the gain, the phase shift, or both.

Another network entity for wireless communications is described. The network entity may include means for performing, for a set of uplink reference signals received from a UE via an uplink channel between the UE and the network entity, a set of measurements associated with one or more spatial characteristics of the set of uplink reference signals, the uplink channel associated with a first set of frequency resources, where the set of uplink reference signals are received in accordance with a first periodicity, means for outputting, via a downlink channel between the UE and the network entity, a first set of downlink reference signals at a second periodicity, the downlink channel associated with a second set of frequency resources different from the first set of frequency resources, where the first set of downlink reference signals are output in accordance with a second periodicity that is less than the first periodicity, means for outputting, via the downlink channel, a second set of downlink reference signals at a third periodicity that is less than the second periodicity, means for obtaining one or more feedback messages indicating a gain of the downlink channel that is based on the first set of downlink reference signals and a phase shift of the downlink channel that is based on the second set of downlink reference signals, and means for communicating one or more messages with the network entity via the downlink channel, the uplink channel, or both, using a set of downlink communication parameters, a set of uplink communication parameters, or both, that are based on the gain, the phase shift, or both.

A non-transitory computer-readable medium storing code for wireless communications is described. The code may include instructions executable by one or more processors to perform, for a set of uplink reference signals received from a UE via an uplink channel between the UE and the network entity, a set of measurements associated with one or more spatial characteristics of the set of uplink reference signals, the uplink channel associated with a first set of frequency resources, where the set of uplink reference signals are received in accordance with a first periodicity, output, via a downlink channel between the UE and the network entity, a first set of downlink reference signals at a second periodicity, the downlink channel associated with a second set of frequency resources different from the first set of frequency resources, where the first set of downlink reference signals are output in accordance with a second periodicity that is less than the first periodicity, output, via the downlink channel, a second set of downlink reference signals at a third periodicity that is less than the second periodicity, obtain one or more feedback messages indicating a gain of the downlink channel that is based on the first set of downlink reference signals and a phase shift of the downlink channel that is based on the second set of downlink reference signals, and communicate one or more messages with the network entity via the downlink channel, the uplink channel, or both, using a set of downlink communication parameters, a set of uplink communication parameters, or both, that are based on the gain, the phase shift, or both.

Some examples of the method, network entities, and non-transitory computer-readable medium described herein may further include operations, features, means, or instructions for performing a first channel estimation of the downlink channel and a second channel estimation of the uplink channel based on the set of measurements performed for the set of uplink reference signals, the gain of the downlink channel, and the phase shift of the downlink channel, where the set of downlink communication parameters and the set of uplink communication parameters may be based on the first channel estimation of the downlink channel and the second channel estimation of the uplink channel.

In some examples of the method, network entities, and non-transitory computer-readable medium described herein, obtaining the one or more feedback messages may include operations, features, means, or instructions for obtaining a first set of feedback messages indicating the gain in accordance with the second periodicity and obtaining a second set of feedback messages indicating the phase shift in accordance with the third periodicity, where communicating the one or more messages may be based on obtaining the first set of feedback messages in accordance with the second periodicity and obtaining the second set of feedback messages in accordance with the third periodicity.

Some examples of the method, network entities, and non-transitory computer-readable medium described herein may further include operations, features, means, or instructions for outputting control signaling indicating the set of downlink communication parameters associated with the downlink channel, the set of uplink communication parameters associated with the uplink channel, or both, based on obtaining the one or more feedback messages indicating the gain and the phase shift associated with the downlink channel.

In some examples of the method, network entities, and non-transitory computer-readable medium described herein, the set of downlink communication parameters, the set of uplink communication parameters, or both, includes a transmission power, a MCS, a precoder matrix, a rank, or any combination thereof.

Some examples of the method, network entities, and non-transitory computer-readable medium described herein may further include operations, features, means, or instructions for outputting a third set of downlink reference signals via the downlink channel in accordance with a fourth periodicity that may be greater than the second periodicity and the third periodicity and obtaining one or more additional feedback messages indicating a channel estimation of the downlink channel based on the third set of downlink reference signals, where the set of downlink communication parameters, the set of uplink communication parameters, or both, may be based on the channel estimation of the downlink channel.

In some examples of the method, network entities, and non-transitory computer-readable medium described herein, the first periodicity, the second periodicity, the third periodicity, or any combination thereof based on the one or more spatial characteristics associated with the set of uplink reference signals and the one or more spatial characteristics include an AoA angle, a ZoA angle, an AoD angle, a ZoD angle, or any combination thereof.

Some examples of the method, network entities, and non-transitory computer-readable medium described herein may further include operations, features, means, or instructions for outputting control signaling indicating a configuration of the first periodicity, the second periodicity, the third periodicity, or any combination thereof.

In some examples of the method, network entities, and non-transitory computer-readable medium described herein, a value of the second periodicity may be based on the gain associated with the downlink channel being within a threshold amount from a second gain associated with the uplink channel.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports channel estimation in frequency division duplex (FDD) systems in accordance with one or more aspects of the present disclosure.

FIG. 2 shows an example of a wireless communications system that supports channel estimation in FDD systems in accordance with one or more aspects of the present disclosure.

FIG. 3 shows an example of a timing diagram that supports channel estimation in FDD systems in accordance with one or more aspects of the present disclosure.

FIG. 4 shows an example of a process flow that supports channel estimation in FDD systems in accordance with one or more aspects of the present disclosure.

FIGS. 5 and 6 show block diagrams of devices that support channel estimation in FDD systems in accordance with one or more aspects of the present disclosure.

FIG. 7 shows a block diagram of a communications manager that supports channel estimation in FDD systems in accordance with one or more aspects of the present disclosure.

FIG. 8 shows a diagram of a system including a device that supports channel estimation in FDD systems in accordance with one or more aspects of the present disclosure.

FIGS. 9 and 10 show block diagrams of devices that support channel estimation in FDD systems in accordance with one or more aspects of the present disclosure.

FIG. 11 shows a block diagram of a communications manager that supports channel estimation in FDD systems in accordance with one or more aspects of the present disclosure.

FIG. 12 shows a diagram of a system including a device that supports channel estimation in FDD systems in accordance with one or more aspects of the present disclosure.

FIGS. 13 and 14 show flowcharts illustrating methods that support channel estimation in FDD systems in accordance with one or more aspects of the present disclosure.

### DETAILED DESCRIPTION

In some wireless communication systems, a user equipment (UE) and a network entity may estimate a downlink communication channel and an uplink communication channel based on one or more downlink reference signals or uplink reference signals, respectively. In some systems, the UE and the network entity may communicate using time division duplex (TDD) techniques in which uplink and downlink messages may be transmitted via the same set of frequency resources (e.g., and different time resources). In such examples, the UE and the network entity may determine that the downlink communication channel and the uplink communication channel may have reciprocity. That is, the downlink communication channel and the uplink communication channel may share one or more characteristics such that the downlink channel may be estimated based on estimating the uplink channel (e.g., and vice versa).

In some examples, however, the UE and the network entity may communicate using frequency division duplex (FDD) techniques in which uplink and downlink messages may be transmitted via different sets of frequency resources. In such examples, the uplink channel and the downlink channel may have relatively less reciprocity as compared with TDD systems. Without reciprocity, assumptions or characteristics determined for the downlink channel may not necessarily apply to the uplink channel, and vice versa. Accordingly, the UE and the network entity may have to perform separate measurements and reporting for the downlink and uplink channels, resulting in higher signaling overhead used for channel estimation and reporting as compared with TDD systems, which may increase latency and overhead associated with channel estimation.

Accordingly, techniques described herein may enable a UE and a network entity communicating via FDD techniques to perform an estimation of a downlink channel (e.g., and an uplink channel) based on measurements of the uplink channel and the downlink channel. In particular, techniques described herein may take advantage of some common features/characteristics of FDD downlink and uplink channels to reduce channel measurements and reporting even when the FDD downlink and uplink channels are not fully reciprocal (e.g., for partial reciprocity across the downlink and uplink channels). Techniques described herein may result in relatively fewer measurements of the downlink channel as are performed for a full channel estimation.

For example, the network entity may perform measurements of one or more uplink reference signals and may estimate a quantity of clusters and spatial characteristics associated with the uplink reference signals. The UE may perform measurements of one or more downlink reference signals and may estimate a gain and phase shift associated with the downlink reference signals. The UE may feedback the gain and phase shift to the network entity, and the network entity may estimate the downlink channel based on the gain, phase shift, and spatial characteristics. In some aspects, the UE may measure and report gain and phase shift of the downlink channel with different periodicities. The network entity may configure one or more communication parameters associated with the uplink and downlink channels based on the estimation. Such techniques may reduce a signaling overhead associated with estimation of the downlink channel.

Aspects of the disclosure are initially described in the context of wireless communications systems. Aspects of the disclosure are further illustrated by and described with reference to timing diagrams, process flows, apparatus diagrams, system diagrams, and flowcharts that relate to performing channel estimation in FDD systems.

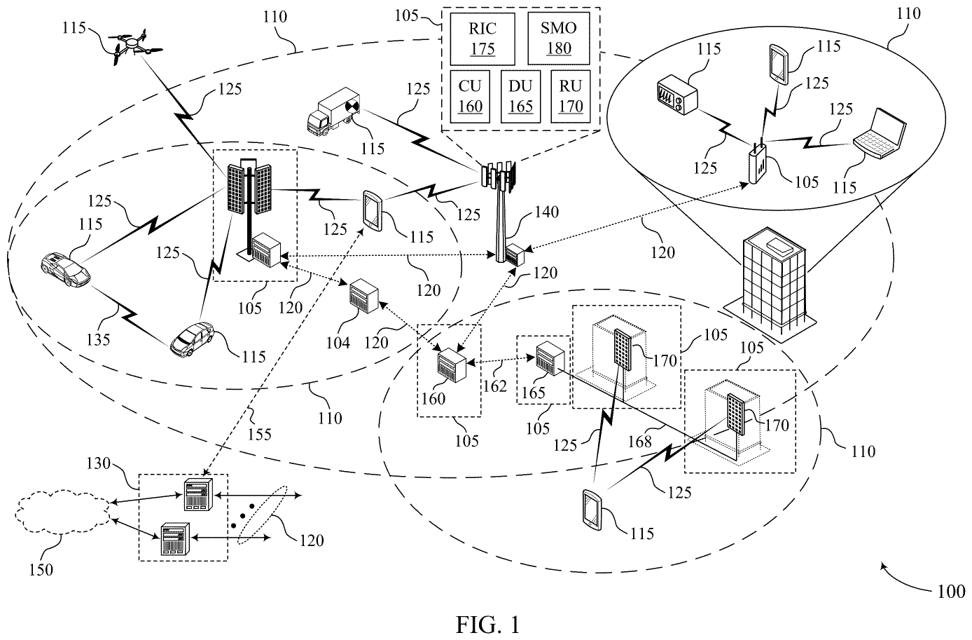

FIG. 1 shows an example of a wireless communications system 100 that supports channel estimation in FDD systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support performing channel estimation in FDD systems as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both FDD and TDD component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a UE 115 and a network entity 105 communicating via FDD techniques may perform an estimation of a downlink channel (e.g., and an uplink channel) based on measurements of the uplink channel and the downlink channel based on a partial reciprocity of the uplink channel and the downlink channel. For example, the network entity 105 may perform measurements of one or more uplink reference signals and may estimate a quantity of clusters and spatial characteristics associated with the uplink reference signals. The UE 115 may perform measurements of one or more downlink reference signals and may estimate a gain and phase shift associated with the downlink reference signals. The UE 115 may feedback the gain and phase shift to the network entity 105, and the network entity 105 may estimate the downlink channel based on the gain, phase shift, and spatial characteristics. In some aspects, the UE may measure and report gain and phase shift of the downlink channel with different periodicities.

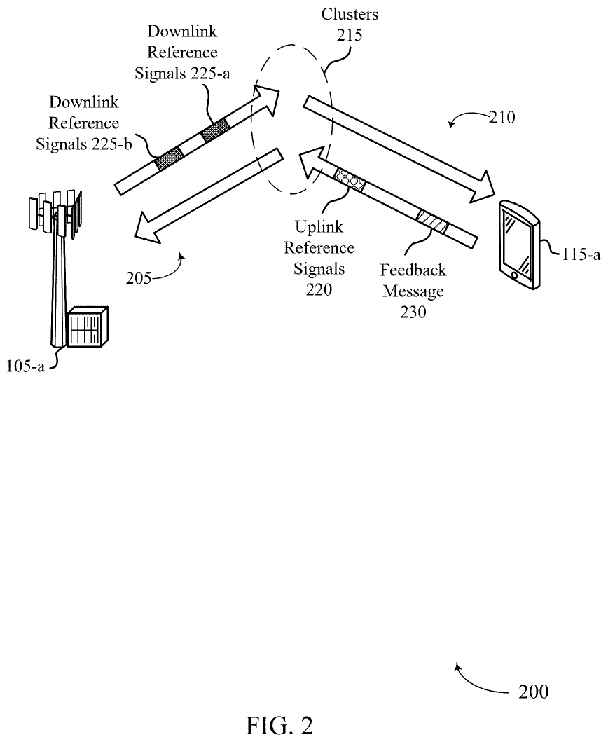

FIG. 2 shows an example of a wireless communications system 200 that supports channel estimation in FDD systems in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or a network entity 105 (e.g., a network entity 105-a), which may be examples of the corresponding devices as described with reference to FIG. 1.

In some examples of the wireless communications system 200, a UE 115-a may communicate with a network entity 105-a via one or more channels. For example, the UE 115-a may transmit one or more uplink messages to the network entity 105-a via an uplink channel 205, and the network entity 105-b may transmit one or more downlink messages to the UE 115-a via a downlink channel 210.

In some examples, wireless communications between the UE 115-a and the network entity 105-a may propagate through space via one or more clusters 215. As described herein, a cluster 215 may be an object (e.g., a metallic object, a glass object, another reflective object) in an environment of the wireless communications system 200 via which communications over the uplink channel 205 and the downlink channel 210 may propagate between the network entity and the UE 115-a. For example, the communications may be reflected off of the object from the network entity 105-a to the UE 115-a (e.g., or vice versa). Accordingly, each channel may be associated with one or more angles of arrival and angles of departure. For example, the downlink channel 210 may be associated with an azimuth angle of arrival (AoA) φ_{R,nm} and a zenith angle of arrival (ZoA) θ_{R,nm} describing a direction in which the communications are received by the UE 115-a, and an azimuth angle of departure (AoD) φ_{T,nm} and a zenith angle of departure (ZoD) θ_{T,nm} describing a direction in which the communications are transmitted from the network entity 105-a. Conversely, the uplink channel 205 may be associated with an AoA φ_{R,nm} and a ZoA θ_{R,nm} describing a direction in which the communications are received by the network entity 105-a, and an AoD PT nm and a ZoD θ_{T,nm} describing a direction in which the communications are transmitted from the UE 115-a.

In some examples, the UE 115-a and the network entity 105-a may communicate using one or more communication parameters (e.g., a transmission power, a modulation and coding scheme (MCS), a precoder matrix, a rank, etc.) that may be based on channel estimation of the uplink channel and the downlink channel. For example, the UE 115-a may transmit one or more uplink reference signals 220 to the network entity 105-a, and the network entity 105-a may estimate one or more characteristics of the uplink channel 205 and the downlink channel 210 (e.g., based on a reciprocity between the uplink channel 205 and the downlink channel 210. The network entity 105-a may accordingly determine a set of communication parameters that may increase a quality of communication in the wireless communications system 200, and may configure the UE 115-a with the communication parameters.

In some examples, the UE 115-a and the network entity 105-a may use uplink and downlink beams with beam correspondence, which may reduce (e.g., minimize) the overhead associated with channel estimation according to the described techniques. For example, in TDD systems, the UE 115-a and the network entity 105-a may transmit and receive uplink and downlink communications via a same set of frequency resources (e.g., with the same RF properties). Accordingly, the uplink channel 205 and the downlink channel 210 may have an amount of reciprocity. That is, the network entity 105-a may estimate one or more characteristics of the downlink channel 210 based on measurements of the uplink channel (e.g., via the uplink reference signals 220), and vice versa. Such reciprocity may decrease the latencies associated with beamforming (e.g., initial acquisition of beams, beam refinement, or beam failure recovery), which may decrease an overall latency and increase a quality of communications in the wireless communications system 200.

In some examples, however, the UE 115-a and the network entity 105-a may communicate according to FDD techniques. That is, the UE 115-a and the network entity 105-a may transmit and receive uplink and downlink communications via a different sets of frequency resources (e.g., with different RF properties). The uplink channel 205 and the downlink channel 210 may therefore be relatively less reciprocal as compared to TDD systems. That is, in such systems, some FDD uplink and downlink communication parameters may not be reciprocal (e.g., a subset of these parameters may be reciprocal). In such examples, the network entity 105-a may obtain an estimation of the downlink channel 210 via downlink reference signals 225 and an estimation of the uplink channel 205 via uplink reference signals 220. In such examples, the UE 115-a may transmit a feedback message 230 indicating measurements of the downlink channel 210 (e.g., a channel estimation), which may increase overhead and power consumption associated with the network entity 105-a obtaining the channel estimation of the downlink channel 210.

Accordingly, in some aspects, the network entity 105-a and the UE 115-a may leverage a cluster channel structure of uplink channels 205 and downlink channels 210 to obtain estimations of the downlink channel 210 and the uplink channel 205. For example, the network entity 105-a and the UE 115-a may use one or more signaling mechanisms that may enable the UE 115-a and the network entity 105-a to determine (e.g., learn) a channel reciprocity in FDD systems.

For example, in examples in which the wireless communications system 200 includes one or more clusters 215 corresponding to propagation between a transmitting device (e.g., the UE 115-a or the network entity 105-a) and a receiving device (e.g., the UE 115-a or the network entity 105-a), each cluster 215 may be characterized by a respective AoA, ZoA, AoD, ZoD, angular spread (e.g., in azimuth and elevation with multiple rays over the angular spread), delay spread, a change in gain over a respective channel (e.g., |αₙₘ| for the downlink channel 210 and |βₙₘ| for the uplink channel 205), and a phase shift over a respective channel (e.g., σₙₘ for the downlink channel 210 and Enm for the uplink channel 205).

In some examples, the network entity 105-a and the UE 115-a may assume that a first set of frequency resources associated with the uplink channel 205 and a second set of frequency resources associated with the downlink channel 210 are relatively similar (e.g., with a same cluster channel structure). That is, an uplink channel estimation H_{UL} and a downlink channel estimation H_{DL} may be different (e.g., on a per-realization or temporal evolution basis), but may be associated with same cluster, angle, and delay information. That is, uplink signals may be transmitted by the UE 115-a using a specific set of AoDs/ZoDs, be reflected or otherwise propagate via the set of clusters 215, and may be received by the network entity 105-a using a specific set of AoAs/ZoAs. In the opposite direction, the downlink clusters 215 over which the signals propagate may be the same, where the only difference is that the AoDs/ZoDs and the AoAs/ZoAs are flipped (e.g., AoD/ZoD of uplink signals is now the AoA/ZoA of the downlink signals).

Accordingly, the downlink and uplink channel estimations may be defined according to Equation 1 and Equation 2, respectively.

$${H}_{D L} = {\sum }_{n m} {α}_{n m} {a}_{R} ( {θ}_{R , nm} , {ϕ}_{R , n m} ) \cdot {{a}_{T} ( {θ}_{T , nm} , {ϕ}_{T , nm} )}^{H} \cdot {e}^{j 2 π {B}_{d} t ( \vec{{r}_{n m}} \cdot \vec{v} )} \cdot {e}^{- j 2 π k δ {τ}_{n m}} \qquad ( 1 )$$

$$( 2 )$$

$${H}_{UL} = {\sum }_{n m} {β}_{n m} {a}_{T} ( {θ}_{T , nm} , {ϕ}_{T , nm} ) \cdot {{a}_{R} ( {θ}_{R , nm} , {ϕ}_{R , n m} )}^{H} \cdot {e}^{j 2 π {B}_{d} t ( \vec{{r}_{n m}} \cdot \vec{v} )} {e}^{- j 2 π k δ {τ}_{n m}}$$

where H_{UL} is the channel estimation of the uplink channel, H_{DL} is the channel estimation of the downlink channel, αₙₘ defines the gain of the downlink channel, and βₙₘ defines the gain of the uplink channel. Further, n and m define a cluster index and ray index within each cluster, H defines the channel matrix, B_{d} defines Doppler bandwidth, t defines time, \vec{rₙₘ} defines a cluster's propagation direction based on its angular information, \vec{ν} defines UE mobility vector, k defines the subcarrier index, δ defines the subcarrier spacing, and τₙₘ defines delay information. In some aspects, the gain of the downlink channel αₙₘ may be defined as |αₙₘ|e^{jν}^{ₙₘ}, and the gain of the uplink channel βₙₘ may be defined as |βₙₘ|e^{jε}^{ₙₘ}. In general, it may be assumed that |αₙₘ|≠|βₙₘ| and νₙₘ≠εₙₘ.

As described previously herein, one or more spatial characteristics associated with the uplink channel 205 and the downlink channel 210 (e.g., AoA, ZoA, AoD, ZOD, delay information) may be relatively similar for the uplink channel 205 as for the downlink channel 210. Additionally, or alternatively, the UE 115-a may determine the spatial characteristics of the downlink channel 210 and feed back the spatial characteristics to the network entity 105-a. Accordingly, the parameters αₙₘ and βₙₘ (e.g., gain and phase information) may be a main difference between the estimation of the uplink channel 205 and the estimation of the downlink channel 210 across rays or clusters 215.

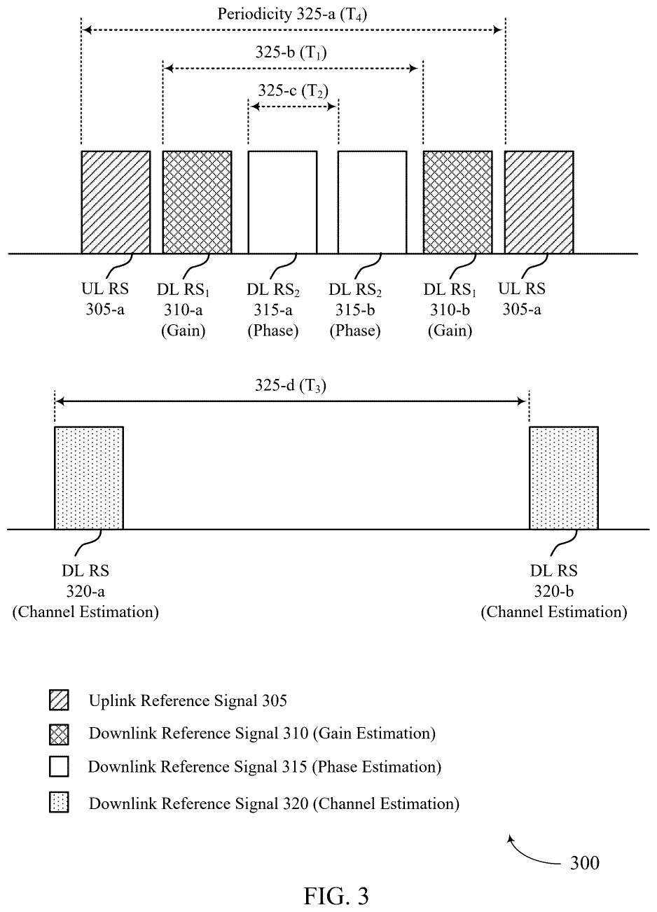

In some aspects, the UE 115-a and the network entity 105-a may determine one or more time-scales (e.g., periodicities) for the UE 115-a to measure downlink reference signals 225-a (e.g., downlink reference signals associated with gain measurements) and downlink reference signals 225-b (e.g., downlink reference signals associated with phase shift measurements). The UE 115-a may transmit one or more feedback messages 230 to the network entity 105-a indicating the gain and phase shift measurements. The UE 115-a and the network entity 105-a may determine one or more additional time-scales (e.g., periodicities) for the UE 115-a to transmit uplink reference signals 220 to the network entity 105-a such that the network entity 105-a may determine spatial configurations (e.g., AoA, ZoA, AoD, ZoD, and/or a quantity of clusters 215) associated with the uplink channel. The network entity 105-a may accordingly obtain estimations of the uplink channel 205 and the downlink channel 210. The time-scales for the uplink reference signals 220 and the downlink reference signals 225 are illustrated and described in further detail herein with reference to FIG. 3.

In some examples, the network entity 105-a may use a calibration approach to fine-tune the time-scale configurations associated with the downlink reference signals 225-a and the downlink reference signals 225-b. The network entity 105-a may configure the UE 115-a with the time-scales for phase and amplitude measurement and reporting based on the obtained channel estimations. Such techniques are described in further detail herein with reference to FIG. 3.

FIG. 3 shows an example of a timing diagram 300 that supports channel estimation in FDD systems in accordance with one or more aspects of the present disclosure. The timing diagram 300 may implement or may be implemented by aspects of the wireless communications system 100 or the wireless communications system 200. For example, the timing diagram 300 may be implemented by a UE 115 or a network entity 105, which may be examples of the corresponding devices as described with reference to FIG. 1.

In some examples, as described with reference to FIG. 2, a network entity 105 and a UE 115 (e.g., a UE 115 in a receiving mode) may perform measurements of one or more reference signals and may use a partial reciprocity of a downlink channel and an uplink channel to estimate the downlink channel (e.g., and the uplink channel) based on the measurements.

The UE 115 may transmit uplink reference signals 305 to the network entity 105 at a periodicity 325-a (e.g., T₄). The network entity 105 may estimate spatial characteristics of the uplink reference signals 305 (e.g., a quantity of clusters, rays, or paths, and cluster information such as angular and delay info, AoA, ZoA, AoD, and ZoD). In some cases, the spatial characteristics may not change over long time-scales. For example, in cases where the UE 115-a is relatively stationary, or is otherwise not moving at high speeds, the relative angles and clusters 215 between the UE 115-a and the network entity 105-a may remain relatively constant. Accordingly, the periodicity 325-a for the uplink reference signals 305 may be relatively longer than a periodicity of some other reference signals. In some examples, the network entity 105 may estimate spatial characteristics of the downlink channel based on the spatial characteristics of the uplink reference signals 305. For example, the spatial characteristics of the downlink channel may be the same as the spatial characteristics of the uplink reference signals 305.

The UE 115 may perform measurements of downlink reference signals to estimate one or more phase terms and one or more amplitude or gain terms. The phase terms (e.g., νₙₘ and εₙₘ) may remain relatively less stable over time as compared to the gain terms (e.g., |αₙₘ| and |βₙₘ|). In other words, the phase of the downlink channel may change faster and more frequently as compared to the gain. Accordingly, the UE 115 may perform measurements of gain estimation downlink reference signals 310 relatively less frequently as compared to measurements of phase estimation reference signals 315. That is, a periodicity 325-b (e.g., T₁) of gain estimation downlink reference signals 310 may be relatively larger than a periodicity 325-c (e.g., T₂) of phase estimation reference signals 315.

The periodicity 325-a may be relatively larger than the periodicity 325-b and the periodicity 325-c. That is, a time between an uplink reference signal 305-a and an uplink reference signal 305-b may be relatively larger than a time between a gain estimation downlink reference signal 310-a and a gain estimation downlink reference signal 310-b. The time between the gain estimation downlink reference signal 310-a and the gain estimation downlink reference signal 310-b may be relatively larger than a time between a phase estimation downlink reference signal 315-a and a phase estimation downlink reference signal 315-b (e.g., such that T₄>T₁> T₂).

The UE may estimate, based on measurements of the gain estimation downlink reference signals 310 and the phase estimation downlink reference signals 315, the gain and phase of each path. In some examples, the UE 115 may measure the gain and phase associated with the downlink channel (e.g., |αₙₘ| and νₙₘ) and may use a look-up table to estimate the gain and phase associated with the uplink channel (e.g., (βₙₘ| and εₙₘ). The look-up table may include information that correlates the gain and phase of a set of frequency resources associated with the uplink channel and a set of frequency resources associated with the downlink channel. The UE 115 may transmit feedback messages to the network entity 105 to report the values of the gain and phase associated with the downlink channel (e.g., and/or the values of the gain and phase associated with the uplink channel).

The UE 115 may transmit the feedback messages indicating the gain and the feedback messages indicating the phase at the periodicity 325-b and the periodicity 325-c, respectively. In some aspects, the network entity 105 may configure the periodicity 325-b and the periodicity 325-c (e.g., T₁ and T₂) for the reporting of amplitude (gain) and phase term estimates. The feedback may accordingly enable the network entity 105 to estimate the downlink channel H_{DL}.

In some examples, the UE 115 may estimate the downlink channel H_{DL} based on performing measurements of a set of channel estimation downlike reference signals 320 at a periodicity 325-d (e.g., T₃). The UE 115 may transmit feedback messages indicating a full channel state information (CSI) report to the network entity 105 at the periodicity 325-d. In some examples, an overhead associated with reporting the full CSI may be relatively higher than an overhead associated with reporting the gain and phase (e.g., partial CSI feedback). Accordingly, the network entity 105 may configure the periodicity 325-d to be relatively larger than the periodicity 325-b and the periodicity 325-c. That is, a time between a channel estimation downlink reference signal 320-a and channel estimation downlink reference signal 320-b may be relatively larger than the time between the gain estimation downlink reference signal 310-a and the gain estimation downlink reference signal 310-b. can configure time-scales (denoted as T₃, which can be much less frequent) for full CSI feedback than at which partial feedback is provided (e.g., such that T₃>T₄>T₁>T₂).

The network entity 105 may obtain an estimation of the downlink channel from the full CSI feedback. Such an estimation may be relatively more accurate than the estimation obtained based on the partial CSI feedback. Accordingly, the network entity 105 may compare the estimation of the downlink channel based on the full CSI feedback and the estimation obtained based on the partial CSI feedback. The network entity 105 may perform a calibration of time-scale adaptation (e.g., to adjust the values of the periodicity 325-a, the periodicity 325-b, the periodicity 325-c, and/or the periodicity 325-d) based on the comparison.

In some examples, the network entity 105 may perform the calibration of time-scale adaptation (e.g., to adjust the values of the periodicity 325-a, the periodicity 325-b, the periodicity 325-c, and/or the periodicity 325-d) based on the estimation of the AoA and ZoA values. For example, if the AoA and ZoA are relatively close (e.g., below a configured angular threshold), the network entity 105 may configure the periodicity 325-a, the periodicity 325-b, the periodicity 325-c, and/or the periodicity 325-d to be relatively smaller. For example, if the AoA and ZoA are not relatively close (e.g., above the configured angular threshold), the network entity 105 may configure the periodicity 325-a, the periodicity 325-b, the periodicity 325-c, and/or the periodicity 325-d to be default values (e.g., default large values).

In some examples, if |αₙₘ|≈|βₙₘ|, (e.g., and if the uplink channel and the downlink channel correspond to propagation over similar path distances), the network entity 105 may configure the periodicity 325-b (e.g., T₁) to be a default value (e.g., a default large value).

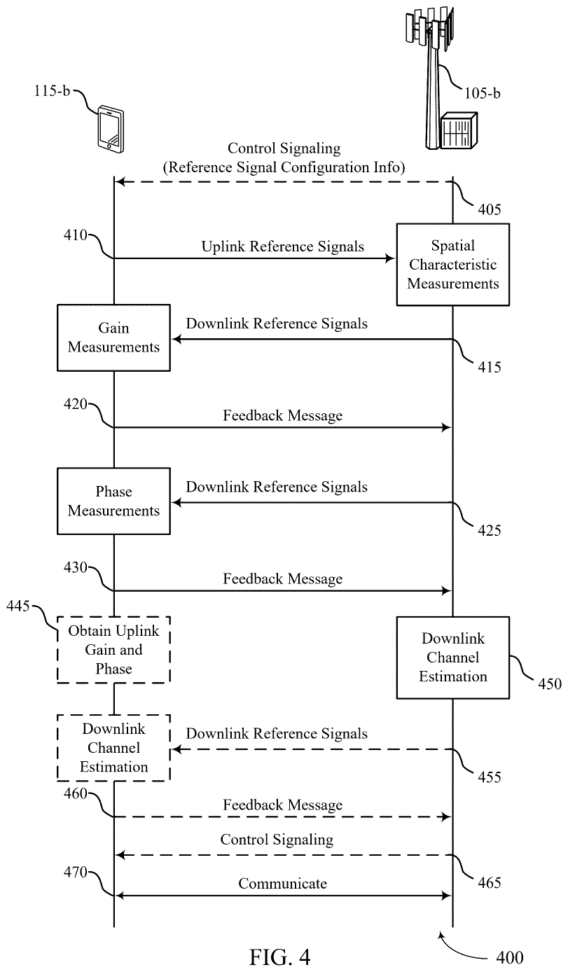

FIG. 4 shows an example of a process flow 400 that supports channel estimation in FDD systems in accordance with one or more aspects of the present disclosure. The process flow 400 may implement or may be implemented by aspects of the wireless communications system 100, the wireless communications system 200, or the timing diagram 300. For example, the process flow 400 may be implemented by a UE 115 (e.g., a UE 115-b) or a network entity 105 (e.g., a network entity 105-b), which may be examples of the corresponding devices as described with reference to FIG. 1.

In the following description of the process flow 400, the operations between the UE 115-b and the network entity 105-b may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At signaling operation 405, the network entity 105-b may output control signaling to the UE 115-b that indicates configuration information for one or more reference signals. For example, the control signaling may indicate a first periodicity associated with a set of uplink reference signals, a second periodicity associated with a first set of downlink reference signals, a third periodicity associated with a second set of downlink reference signals, and/or a fourth periodicity associated with a third set of downlink reference signals. In some examples, the second periodicity may be greater than the third periodicity, the first periodicity may be greater than the second periodicity, and the fourth periodicity may be greater than the first periodicity.

In some examples, the network entity 105-b may determine the first periodicity, the second periodicity, the third periodicity, and the fourth periodicity based on spatial characteristics of the set of uplink reference signals. The spatial characteristics may include an AoA angle, a ZoA angle, an AoD angle, and/or a ZoD angle of an uplink channel between the UE 115-b and the network entity 105-b. In some examples, the network entity 105-b may determine the first periodicity, the second periodicity, the third periodicity, and the fourth periodicity based on a gain of the uplink channel being within a threshold amount of a gain of a downlink channel between the UE 115-b and the network entity 105-b.

At signaling and measurement operation 410, the UE 115-b may transmit one or more uplink reference signals. For example, the UE 115-b may output the uplink reference signals at the first periodicity in accordance with the configuration (e.g., periodicity 325-a, T4). The network entity 105-b may perform a set of measurements of the uplink reference signals associated with the spatial characteristics of the uplink channel. In some examples, the uplink channel may be associated with a first set of frequency resources (e.g., uplink frequency resources).

At signaling and measurement operation 415, the UE 115-b may perform measurements of the first downlink reference signals. For example, the network entity 105-b may output the first downlink reference signals at the second periodicity in accordance with the configuration (e.g., periodicity 325-b, T₁). The UE 115-b may perform a set of measurements of the first downlink reference signals associated with the gain of the downlink channel. In some examples, the downlink channel may be associated with a second set of frequency resources (e.g., downlink frequency resources) different from the first set of frequency resources. At feedback operation 420, the UE 115-b may output one or more feedback messages indicating the measurements of the gain (e.g., at the second periodicity).

At signaling and measurement operation 425, the UE 115-b may perform measurements of the second downlink reference signals. For example, the network entity 105-b may output the second downlink reference signals at the third periodicity in accordance with the configuration (e.g., periodicity 325-c, T₂). The UE 115-b may perform a set of measurements of the second downlink reference signals associated with a phase shift of the downlink channel. At feedback operation 430, the UE 115-b may output one or more feedback messages indicating the measurements of the gain (e.g., at the third periodicity).

In some examples, at operation 445, the UE 115-b may obtain the gain and a phase shift associated with the uplink channel. For example, the UE 115-b may identify the gain and phase shift associated with the uplink channel based on a look-up table that associates the gain and phase shift of the downlink channel with respective gain and phase shift values of the uplink channel.

At channel operation 450, the network entity 105-b may perform an estimation of the downlink channel and/or the uplink channel. For example, the network entity 105-b may generate the estimation of the downlink channel based on the spatial characteristics of the uplink channel, the gain of the downlink channel, and the phase shift of the downlink channel. In some examples, the network entity 105-b may generate one or more communication parameters (e.g., a transmission power, a MCS, a precoder matrix, a rank) associated with the downlink channel and/or the uplink channel based on the estimation.

In some examples, at signaling and measurement operation 455, the UE 115-b may perform measurements of the third downlink reference signals. For example, the network entity 105-b may output the third downlink reference signals at the fourth periodicity in accordance with the configuration (e.g., periodicity 325-d, T₃). The UE 115-b may perform a set of measurements of the second downlink reference signals and may generate an estimation of the downlink channel. At feedback operation 460, the UE 115-b may output one or more feedback messages indicating the estimation of the downlink channel (e.g., at the third periodicity). In some examples, the network entity 105-b may generate one or more communication parameters (e.g., a transmission power, a MCS, a precoder matrix, a rank) associated with the downlink channel and/or the uplink channel based on the estimation.

In some examples, at signaling operation 465, the UE 115-b may receive, from the network entity 105-b, control signaling indicating the communication parameters associated with the downlink channel and/or the uplink channel. At signaling operation 470, the UE 115-b and the network entity 105-b may communicate according to the communication parameters via the uplink channel and the downlink channel.

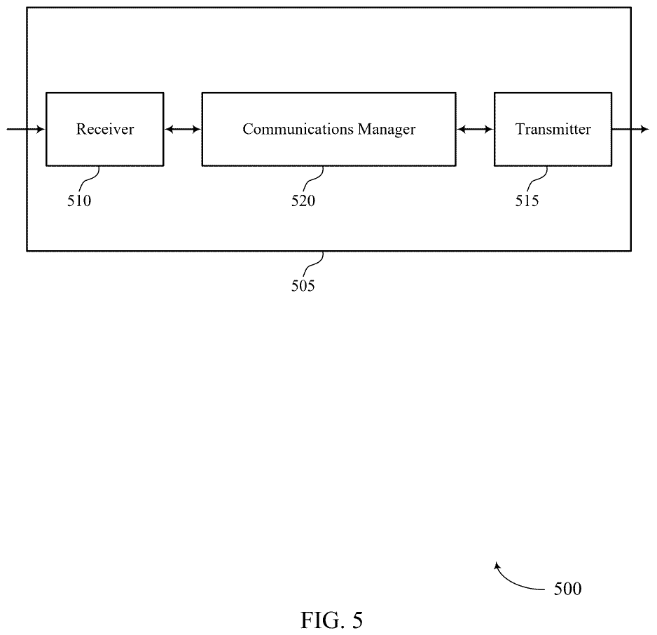

FIG. 5 shows a block diagram 500 of a device 505 that supports channel estimation in FDD systems in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to performing channel estimation in FDD systems). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to performing channel estimation in FDD systems). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of performing channel estimation in FDD systems as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting, via an uplink channel between the UE and a network entity, one or more uplink reference signals at a first periodicity, the uplink channel associated with a first set of frequency resources. The communications manager 520 is capable of, configured to, or operable to support a means for performing, for a first set of downlink reference signals received via a downlink channel between the UE and the network entity, a first set of measurements associated with a gain of the downlink channel, the downlink channel associated with a second set of frequency resources different from the first set of frequency resources, where the first set of downlink reference signals are received in accordance with a second periodicity that is less than the first periodicity. The communications manager 520 is capable of, configured to, or operable to support a means for performing, for a second set of downlink reference signals received via the downlink channel, a second set of measurements associated with a phase shift of the downlink channel, where the second set of downlink reference signals are received in accordance with a third periodicity that is less than the second periodicity. The communications manager 520 is capable of, configured to, or operable to support a means for transmitting one or more feedback messages indicating the gain associated and the phase shift associated with the downlink channel. The communications manager 520 is capable of, configured to, or operable to support a means for communicating one or more messages with the network entity via the downlink channel, the uplink channel, or both, using a set of downlink communication parameters, a set of uplink communication parameters, or both, that are based on the gain, the phase shift, or both.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for channel estimation using channel reciprocity in FDD systems, which may enable more efficient utilization of communication resources.

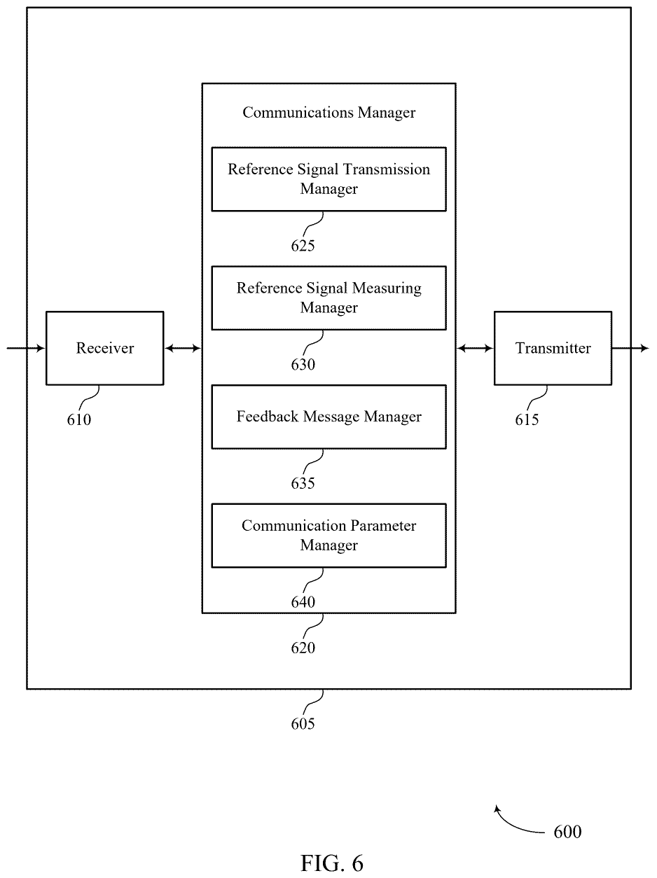

FIG. 6 shows a block diagram 600 of a device 605 that supports channel estimation in FDD systems in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to performing channel estimation in FDD systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to performing channel estimation in FDD systems). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of performing channel estimation in FDD systems as described herein. For example, the communications manager 620 may include a reference signal transmission manager 625, a reference signal measuring manager 630, a feedback message manager 635, a communication parameter manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The reference signal transmission manager 625 is capable of, configured to, or operable to support a means for transmitting, via an uplink channel between the UE and a network entity, one or more uplink reference signals at a first periodicity, the uplink channel associated with a first set of frequency resources. The reference signal measuring manager 630 is capable of, configured to, or operable to support a means for performing, for a first set of downlink reference signals received via a downlink channel between the UE and the network entity, a first set of measurements associated with a gain of the downlink channel, the downlink channel associated with a second set of frequency resources different from the first set of frequency resources, where the first set of downlink reference signals are received in accordance with a second periodicity that is less than the first periodicity. The reference signal measuring manager 630 is capable of, configured to, or operable to support a means for performing, for a second set of downlink reference signals received via the downlink channel, a second set of measurements associated with a phase shift of the downlink channel, where the second set of downlink reference signals are received in accordance with a third periodicity that is less than the second periodicity. The feedback message manager 635 is capable of, configured to, or operable to support a means for transmitting one or more feedback messages indicating the gain associated and the phase shift associated with the downlink channel. The communication parameter manager 640 is capable of, configured to, or operable to support a means for communicating one or more messages with the network entity via the downlink channel, the uplink channel, or both, using a set of downlink communication parameters, a set of uplink communication parameters, or both, that are based on the gain, the phase shift, or both.

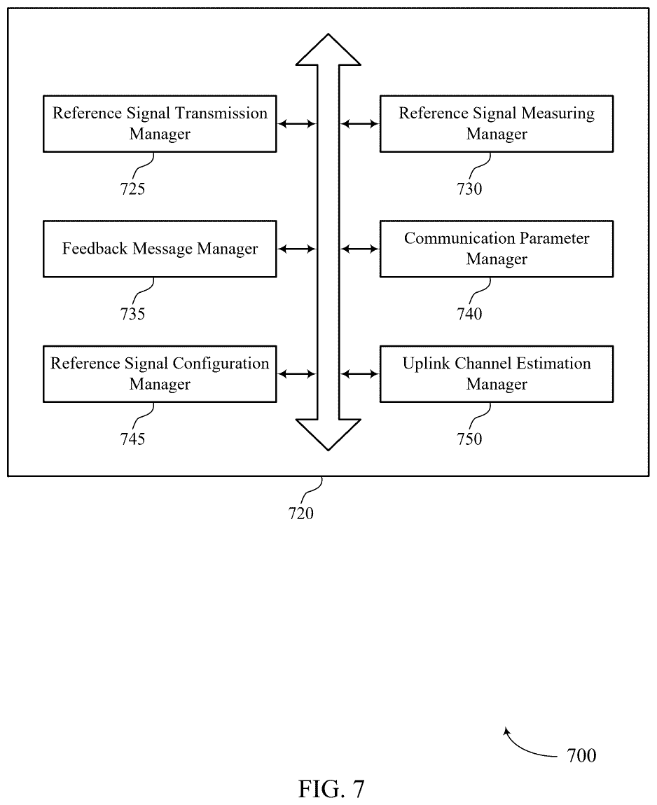

FIG. 7 shows a block diagram 700 of a communications manager 720 that supports channel estimation in FDD systems in accordance with one or more aspects of the present disclosure. The communications manager 720 may be an example of aspects of a communications manager 520, a communications manager 620, or both, as described herein. The communications manager 720, or various components thereof, may be an example of means for performing various aspects of performing channel estimation in FDD systems as described herein. For example, the communications manager 720 may include a reference signal transmission manager 725, a reference signal measuring manager 730, a feedback message manager 735, a communication parameter manager 740, a reference signal configuration manager 745, an uplink channel estimation manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The reference signal transmission manager 725 is capable of, configured to, or operable to support a means for transmitting, via an uplink channel between the UE and a network entity, one or more uplink reference signals at a first periodicity, the uplink channel associated with a first set of frequency resources. The reference signal measuring manager 730 is capable of, configured to, or operable to support a means for performing, for a first set of downlink reference signals received via a downlink channel between the UE and the network entity, a first set of measurements associated with a gain of the downlink channel, the downlink channel associated with a second set of frequency resources different from the first set of frequency resources, where the first set of downlink reference signals are received in accordance with a second periodicity that is less than the first periodicity. In some examples, the reference signal measuring manager 730 is capable of, configured to, or operable to support a means for performing, for a second set of downlink reference signals received via the downlink channel, a second set of measurements associated with a phase shift of the downlink channel, where the second set of downlink reference signals are received in accordance with a third periodicity that is less than the second periodicity. The feedback message manager 735 is capable of, configured to, or operable to support a means for transmitting one or more feedback messages indicating the gain associated and the phase shift associated with the downlink channel. The communication parameter manager 740 is capable of, configured to, or operable to support a means for communicating one or more messages with the network entity via the downlink channel, the uplink channel, or both, using a set of downlink communication parameters, a set of uplink communication parameters, or both, that are based on the gain, the phase shift, or both.

In some examples, to support transmitting the one or more feedback messages, the feedback message manager 735 is capable of, configured to, or operable to support a means for transmitting a first set of feedback messages indicating the gain in accordance with the second periodicity. In some examples, to support transmitting the one or more feedback messages, the feedback message manager 735 is capable of, configured to, or operable to support a means for transmitting a second set of feedback messages indicating the phase shift in accordance with the third periodicity, where communicating the one or more messages is based on transmitting the first set of feedback messages in accordance with the second periodicity and transmitting the second set of feedback messages in accordance with the third periodicity.

In some examples, the communication parameter manager 740 is capable of, configured to, or operable to support a means for receiving, from the network entity, control signaling indicating the set of downlink communication parameters associated with the downlink channel, the set of uplink communication parameters associated with the uplink channel, or both, based on transmitting the one or more feedback messages indicating the gain and the phase shift associated with the downlink channel.

In some examples, the set of downlink communication parameters, the set of uplink communication parameters, or both, includes a transmission power, a MCS, a precoder matrix, a rank, or any combination thereof.

In some examples, the reference signal measuring manager 730 is capable of, configured to, or operable to support a means for receiving a third set of downlink reference signals from the network entity via the downlink channel in accordance with a fourth periodicity that is greater than the second periodicity and the third periodicity. In some examples, the reference signal measuring manager 730 is capable of, configured to, or operable to support a means for performing a channel estimation of the downlink channel based on receiving the third set of downlink reference signals. In some examples, the feedback message manager 735 is capable of, configured to, or operable to support a means for transmitting one or more additional feedback messages indicating the channel estimation of the downlink channel, where the set of downlink communication parameters, the set of uplink communication parameters, or both, are based on the channel estimation of the downlink channel.

In some examples, the first periodicity, the second periodicity, the third periodicity, or any combination thereof, are based on one or more spatial characteristics associated with the one or more uplink reference signals.

In some examples, the one or more spatial characteristics associated with the one or more uplink reference signals include an AoA angle, a ZoA angle, an AoD angle, a ZoD angle, or any combination thereof.

In some examples, the reference signal configuration manager 745 is capable of, configured to, or operable to support a means for receiving control signaling indicating a configuration of the first periodicity, the second periodicity, the third periodicity, or any combination thereof.

In some examples, a value of the second periodicity is based on the gain associated with the downlink channel being within a threshold amount from a second gain associated with the uplink channel.

In some examples, the uplink channel estimation manager 750 is capable of, configured to, or operable to support a means for obtaining a second gain and a second phase shift associated with the uplink channel based on the gain and the phase shift associated with the downlink channel.

In some examples, to support obtaining the second gain and the second phase shift, the uplink channel estimation manager 750 is capable of, configured to, or operable to support a means for identifying the second gain and the second phase shift based on a look-up table that associates gain values and phase shift values of the downlink channel with gain values and phase shift values of the uplink channel.

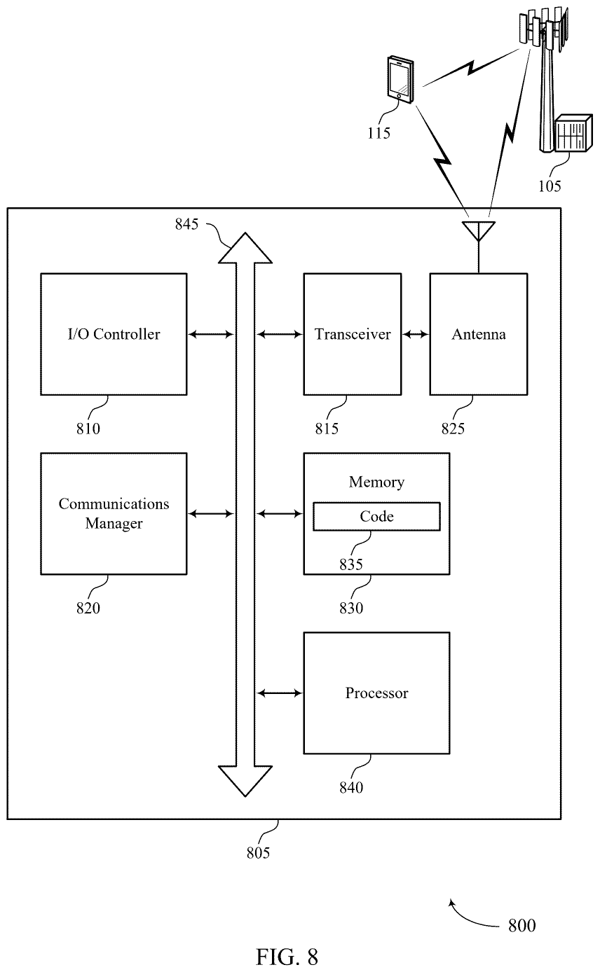

FIG. 8 shows a diagram of a system 800 including a device 805 that supports channel estimation in FDD systems in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting performing channel estimation in FDD systems). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting, via an uplink channel between the UE and a network entity, one or more uplink reference signals at a first periodicity, the uplink channel associated with a first set of frequency resources. The communications manager 820 is capable of, configured to, or operable to support a means for performing, for a first set of downlink reference signals received via a downlink channel between the UE and the network entity, a first set of measurements associated with a gain of the downlink channel, the downlink channel associated with a second set of frequency resources different from the first set of frequency resources, where the first set of downlink reference signals are received in accordance with a second periodicity that is less than the first periodicity. The communications manager 820 is capable of, configured to, or operable to support a means for performing, for a second set of downlink reference signals received via the downlink channel, a second set of measurements associated with a phase shift of the downlink channel, where the second set of downlink reference signals are received in accordance with a third periodicity that is less than the second periodicity. The communications manager 820 is capable of, configured to, or operable to support a means for transmitting one or more feedback messages indicating the gain associated and the phase shift associated with the downlink channel. The communications manager 820 is capable of, configured to, or operable to support a means for communicating one or more messages with the network entity via the downlink channel, the uplink channel, or both, using a set of downlink communication parameters, a set of uplink communication parameters, or both, that are based on the gain, the phase shift, or both.

By including or configuring the communications manager 820 in accordance with examples as described herein, the device 805 may support techniques for channel estimation using channel reciprocity in FDD systems, which may enable improved communication reliability, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of performing channel estimation in FDD systems as described herein, or the at least one processor 840 and the at least one memory 830 may be otherwise configured to, individually or collectively, perform or support such operations.

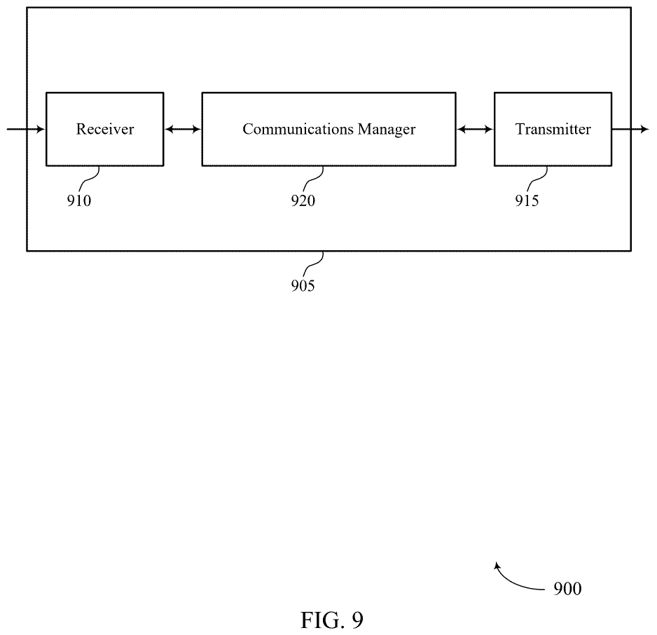

FIG. 9 shows a block diagram 900 of a device 905 that supports channel estimation in FDD systems in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of performing channel estimation in FDD systems as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for performing, for a set of uplink reference signals received from a UE via an uplink channel between the UE and the network entity, a set of measurements associated with one or more spatial characteristics of the set of uplink reference signals, the uplink channel associated with a first set of frequency resources, where the set of uplink reference signals are received in accordance with a first periodicity. The communications manager 920 is capable of, configured to, or operable to support a means for outputting, via a downlink channel between the UE and the network entity, a first set of downlink reference signals at a second periodicity, the downlink channel associated with a second set of frequency resources different from the first set of frequency resources, where the first set of downlink reference signals are output in accordance with a second periodicity that is less than the first periodicity. The communications manager 920 is capable of, configured to, or operable to support a means for outputting, via the downlink channel, a second set of downlink reference signals at a third periodicity that is less than the second periodicity. The communications manager 920 is capable of, configured to, or operable to support a means for obtaining one or more feedback messages indicating a gain of the downlink channel that is based on the first set of downlink reference signals and a phase shift of the downlink channel that is based on the second set of downlink reference signals. The communications manager 920 is capable of, configured to, or operable to support a means for communicating one or more messages with the network entity via the downlink channel, the uplink channel, or both, using a set of downlink communication parameters, a set of uplink communication parameters, or both, that are based on the gain, the phase shift, or both.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for channel estimation using channel reciprocity in FDD systems, which may enable more efficient utilization of communication resources.

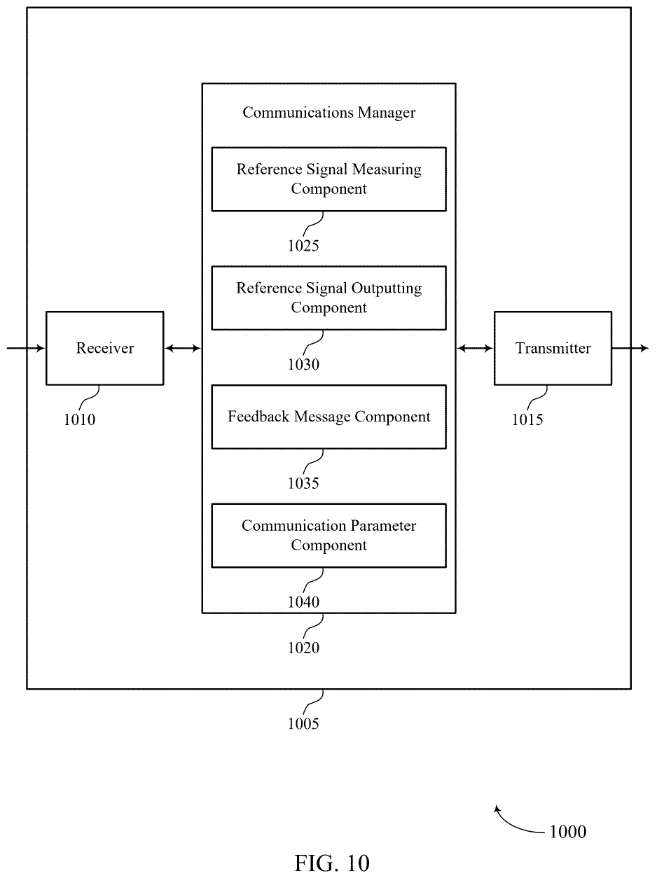

FIG. 10 shows a block diagram 1000 of a device 1005 that supports channel estimation in FDD systems in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of performing channel estimation in FDD systems as described herein. For example, the communications manager 1020 may include a reference signal measuring component 1025, a reference signal outputting component 1030, a feedback message component 1035, a communication parameter component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The reference signal measuring component 1025 is capable of, configured to, or operable to support a means for performing, for a set of uplink reference signals received from a UE via an uplink channel between the UE and the network entity, a set of measurements associated with one or more spatial characteristics of the set of uplink reference signals, the uplink channel associated with a first set of frequency resources, where the set of uplink reference signals are received in accordance with a first periodicity. The reference signal outputting component 1030 is capable of, configured to, or operable to support a means for outputting, via a downlink channel between the UE and the network entity, a first set of downlink reference signals at a second periodicity, the downlink channel associated with a second set of frequency resources different from the first set of frequency resources, where the first set of downlink reference signals are output in accordance with a second periodicity that is less than the first periodicity. The reference signal outputting component 1030 is capable of, configured to, or operable to support a means for outputting, via the downlink channel, a second set of downlink reference signals at a third periodicity that is less than the second periodicity. The feedback message component 1035 is capable of, configured to, or operable to support a means for obtaining one or more feedback messages indicating a gain of the downlink channel that is based on the first set of downlink reference signals and a phase shift of the downlink channel that is based on the second set of downlink reference signals. The communication parameter component 1040 is capable of, configured to, or operable to support a means for communicating one or more messages with the network entity via the downlink channel, the uplink channel, or both, using a set of downlink communication parameters, a set of uplink communication parameters, or both, that are based on the gain, the phase shift, or both.

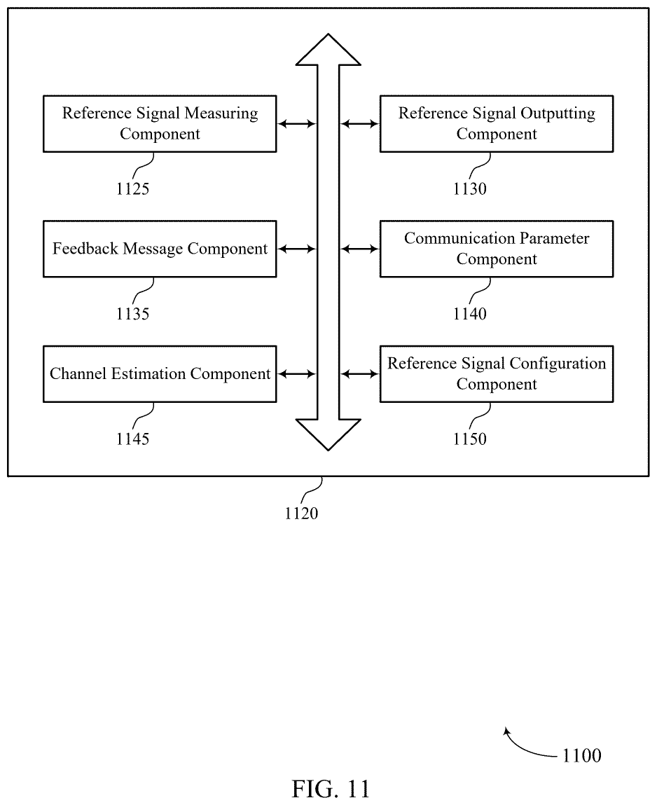

FIG. 11 shows a block diagram 1100 of a communications manager 1120 that supports channel estimation in FDD systems in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of performing channel estimation in FDD systems as described herein. For example, the communications manager 1120 may include a reference signal measuring component 1125, a reference signal outputting component 1130, a feedback message component 1135, a communication parameter component 1140, a channel estimation component 1145, a reference signal configuration component 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The reference signal measuring component 1125 is capable of, configured to, or operable to support a means for performing, for a set of uplink reference signals received from a UE via an uplink channel between the UE and the network entity, a set of measurements associated with one or more spatial characteristics of the set of uplink reference signals, the uplink channel associated with a first set of frequency resources, where the set of uplink reference signals are received in accordance with a first periodicity. The reference signal outputting component 1130 is capable of, configured to, or operable to support a means for outputting, via a downlink channel between the UE and the network entity, a first set of downlink reference signals at a second periodicity, the downlink channel associated with a second set of frequency resources different from the first set of frequency resources, where the first set of downlink reference signals are output in accordance with a second periodicity that is less than the first periodicity. In some examples, the reference signal outputting component 1130 is capable of, configured to, or operable to support a means for outputting, via the downlink channel, a second set of downlink reference signals at a third periodicity that is less than the second periodicity. The feedback message component 1135 is capable of, configured to, or operable to support a means for obtaining one or more feedback messages indicating a gain of the downlink channel that is based on the first set of downlink reference signals and a phase shift of the downlink channel that is based on the second set of downlink reference signals. The communication parameter component 1140 is capable of, configured to, or operable to support a means for communicating one or more messages with the network entity via the downlink channel, the uplink channel, or both, using a set of downlink communication parameters, a set of uplink communication parameters, or both, that are based on the gain, the phase shift, or both.

In some examples, the channel estimation component 1145 is capable of, configured to, or operable to support a means for performing a first channel estimation of the downlink channel and a second channel estimation of the uplink channel based on the set of measurements performed for the set of uplink reference signals, the gain of the downlink channel, and the phase shift of the downlink channel, where the set of downlink communication parameters and the set of uplink communication parameters are based on the first channel estimation of the downlink channel and the second channel estimation of the uplink channel.

In some examples, to support obtaining the one or more feedback messages, the feedback message component 1135 is capable of, configured to, or operable to support a means for obtaining a first set of feedback messages indicating the gain in accordance with the second periodicity. In some examples, to support obtaining the one or more feedback messages, the feedback message component 1135 is capable of, configured to, or operable to support a means for obtaining a second set of feedback messages indicating the phase shift in accordance with the third periodicity, where communicating the one or more messages is based on obtaining the first set of feedback messages in accordance with the second periodicity and obtaining the second set of feedback messages in accordance with the third periodicity.

In some examples, the communication parameter component 1140 is capable of, configured to, or operable to support a means for outputting control signaling indicating the set of downlink communication parameters associated with the downlink channel, the set of uplink communication parameters associated with the uplink channel, or both, based on obtaining the one or more feedback messages indicating the gain and the phase shift associated with the downlink channel.

In some examples, the set of downlink communication parameters, the set of uplink communication parameters, or both, includes a transmission power, a MCS, a precoder matrix, a rank, or any combination thereof.

In some examples, the reference signal outputting component 1130 is capable of, configured to, or operable to support a means for outputting a third set of downlink reference signals via the downlink channel in accordance with a fourth periodicity that is greater than the second periodicity and the third periodicity. In some examples, the feedback message component 1135 is capable of, configured to, or operable to support a means for obtaining one or more additional feedback messages indicating a channel estimation of the downlink channel based on the third set of downlink reference signals, where the set of downlink communication parameters, the set of uplink communication parameters, or both, are based on the channel estimation of the downlink channel.

In some examples, the first periodicity, the second periodicity, the third periodicity, or any combination thereof based on the one or more spatial characteristics associated with the set of uplink reference signals. In some examples, the one or more spatial characteristics include an AoA angle, a ZoA angle, an AoD angle, a ZoD angle, or any combination thereof.

In some examples, the reference signal configuration component 1150 is capable of, configured to, or operable to support a means for outputting control signaling indicating a configuration of the first periodicity, the second periodicity, the third periodicity, or any combination thereof.

In some examples, a value of the second periodicity is based on the gain associated with the downlink channel being within a threshold amount from a second gain associated with the uplink channel.

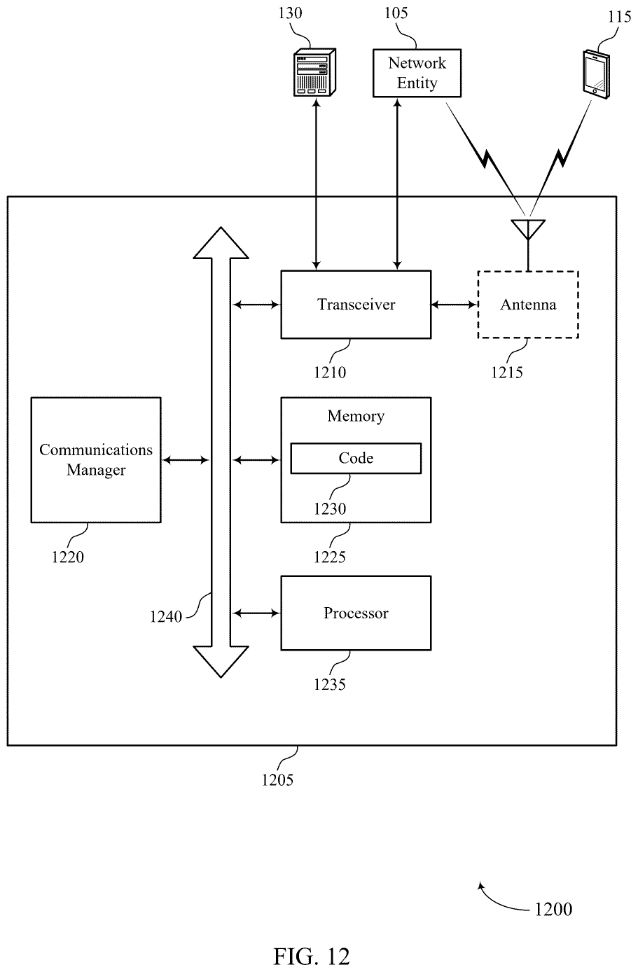

FIG. 12 shows a diagram of a system 1200 including a device 1205 that supports channel estimation in FDD systems in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting performing channel estimation in FDD systems). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for performing, for a set of uplink reference signals received from a UE via an uplink channel between the UE and the network entity, a set of measurements associated with one or more spatial characteristics of the set of uplink reference signals, the uplink channel associated with a first set of frequency resources, where the set of uplink reference signals are received in accordance with a first periodicity. The communications manager 1220 is capable of, configured to, or operable to support a means for outputting, via a downlink channel between the UE and the network entity, a first set of downlink reference signals at a second periodicity, the downlink channel associated with a second set of frequency resources different from the first set of frequency resources, where the first set of downlink reference signals are output in accordance with a second periodicity that is less than the first periodicity. The communications manager 1220 is capable of, configured to, or operable to support a means for outputting, via the downlink channel, a second set of downlink reference signals at a third periodicity that is less than the second periodicity. The communications manager 1220 is capable of, configured to, or operable to support a means for obtaining one or more feedback messages indicating a gain of the downlink channel that is based on the first set of downlink reference signals and a phase shift of the downlink channel that is based on the second set of downlink reference signals. The communications manager 1220 is capable of, configured to, or operable to support a means for communicating one or more messages with the network entity via the downlink channel, the uplink channel, or both, using a set of downlink communication parameters, a set of uplink communication parameters, or both, that are based on the gain, the phase shift, or both.

By including or configuring the communications manager 1220 in accordance with examples as described herein, the device 1205 may support techniques for channel estimation using channel reciprocity in FDD systems, which may enable improved communication reliability, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of performing channel estimation in FDD systems as described herein, or the at least one processor 1235 and the at least one memory 1225 may be otherwise configured to, individually or collectively, perform or support such operations.

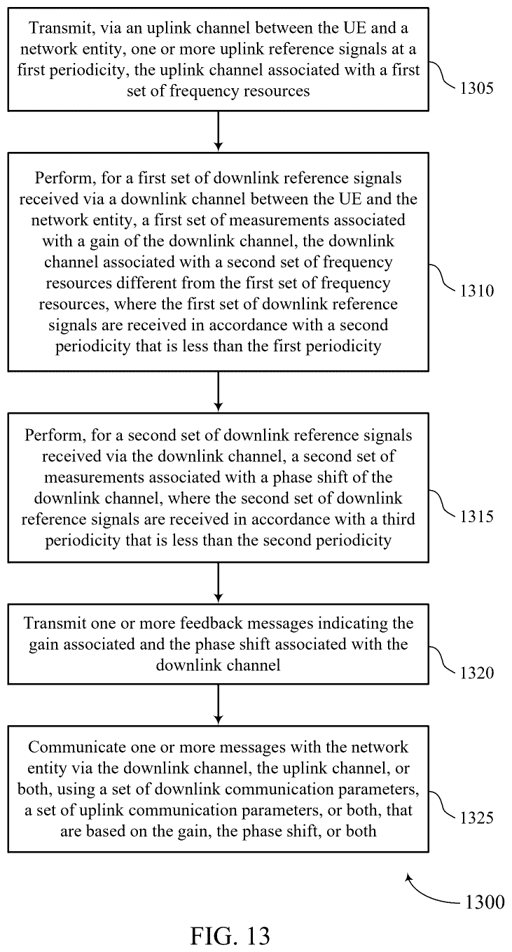

FIG. 13 shows a flowchart illustrating a method 1300 that supports channel estimation in FDD systems in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting, via an uplink channel between the UE and a network entity, one or more uplink reference signals at a first periodicity, the uplink channel associated with a first set of frequency resources. The operations of 1305 may be performed in accordance with examples as disclosed herein. In some examples, aspects of the operations of 1305 may be performed by a reference signal transmission manager 725 as described with reference to FIG. 7.

At 1310, the method may include performing, for a first set of downlink reference signals received via a downlink channel between the UE and the network entity, a first set of measurements associated with a gain of the downlink channel, the downlink channel associated with a second set of frequency resources different from the first set of frequency resources, where the first set of downlink reference signals are received in accordance with a second periodicity that is less than the first periodicity. The operations of 1310 may be performed in accordance with examples as disclosed herein. In some examples, aspects of the operations of 1310 may be performed by a reference signal measuring manager 730 as described with reference to FIG. 7.

At 1315, the method may include performing, for a second set of downlink reference signals received via the downlink channel, a second set of measurements associated with a phase shift of the downlink channel, where the second set of downlink reference signals are received in accordance with a third periodicity that is less than the second periodicity. The operations of 1315 may be performed in accordance with examples as disclosed herein. In some examples, aspects of the operations of 1315 may be performed by a reference signal measuring manager 730 as described with reference to FIG. 7.

At 1320, the method may include transmitting one or more feedback messages indicating the gain associated and the phase shift associated with the downlink channel. The operations of 1320 may be performed in accordance with examples as disclosed herein. In some examples, aspects of the operations of 1320 may be performed by a feedback message manager 735 as described with reference to FIG. 7.

At 1325, the method may include communicating one or more messages with the network entity via the downlink channel, the uplink channel, or both, using a set of downlink communication parameters, a set of uplink communication parameters, or both, that are based on the gain, the phase shift, or both. The operations of 1325 may be performed in accordance with examples as disclosed herein. In some examples, aspects of the operations of 1325 may be performed by a communication parameter manager 740 as described with reference to FIG. 7.

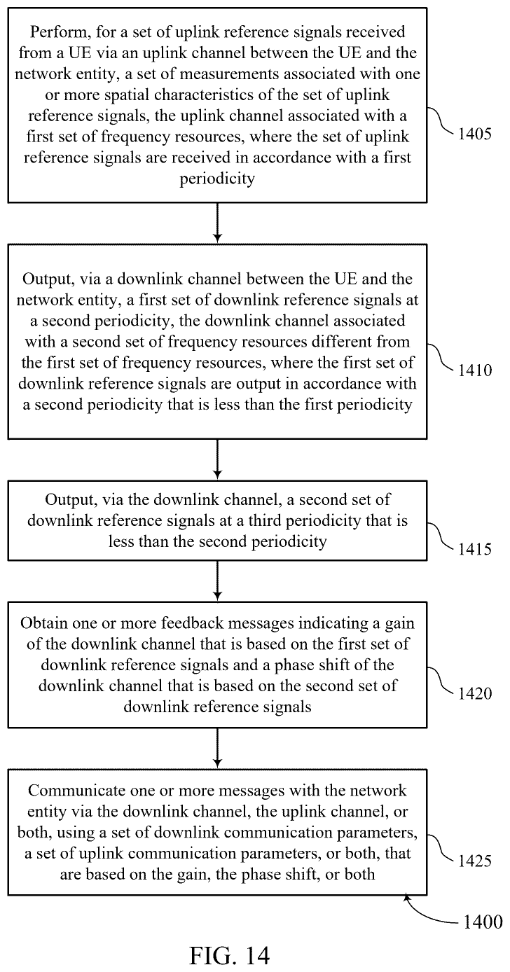

FIG. 14 shows a flowchart illustrating a method 1400 that supports channel estimation in FDD systems in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include performing, for a set of uplink reference signals received from a UE via an uplink channel between the UE and the network entity, a set of measurements associated with one or more spatial characteristics of the set of uplink reference signals, the uplink channel associated with a first set of frequency resources, where the set of uplink reference signals are received in accordance with a first periodicity. The operations of 1405 may be performed in accordance with examples as disclosed herein. In some examples, aspects of the operations of 1405 may be performed by a reference signal measuring component 1125 as described with reference to FIG. 11.

At 1410, the method may include outputting, via a downlink channel between the UE and the network entity, a first set of downlink reference signals at a second periodicity, the downlink channel associated with a second set of frequency resources different from the first set of frequency resources, where the first set of downlink reference signals are output in accordance with a second periodicity that is less than the first periodicity. The operations of 1410 may be performed in accordance with examples as disclosed herein. In some examples, aspects of the operations of 1410 may be performed by a reference signal outputting component 1130 as described with reference to FIG. 11.

At 1415, the method may include outputting, via the downlink channel, a second set of downlink reference signals at a third periodicity that is less than the second periodicity. The operations of 1415 may be performed in accordance with examples as disclosed herein. In some examples, aspects of the operations of 1415 may be performed by a reference signal outputting component 1130 as described with reference to FIG. 11.

At 1420, the method may include obtaining one or more feedback messages indicating a gain of the downlink channel that is based on the first set of downlink reference signals and a phase shift of the downlink channel that is based on the second set of downlink reference signals. The operations of 1420 may be performed in accordance with examples as disclosed herein. In some examples, aspects of the operations of 1420 may be performed by a feedback message component 1135 as described with reference to FIG. 11.

At 1425, the method may include communicating one or more messages with the network entity via the downlink channel, the uplink channel, or both, using a set of downlink communication parameters, a set of uplink communication parameters, or both, that are based on the gain, the phase shift, or both. The operations of 1425 may be performed in accordance with examples as disclosed herein. In some examples, aspects of the operations of 1425 may be performed by a communication parameter component 1140 as described with reference to FIG. 11.

The following provides an overview of aspects of the present disclosure:

Aspect 1: A method for wireless communications by a UE, comprising: transmitting, via an uplink channel between the UE and a network entity, one or more uplink reference signals at a first periodicity, the uplink channel associated with a first set of frequency resources; performing, for a first set of downlink reference signals received via a downlink channel between the UE and the network entity, a first set of measurements associated with a gain of the downlink channel, the downlink channel associated with a second set of frequency resources different from the first set of frequency resources, wherein the first set of downlink reference signals are received in accordance with a second periodicity that is less than the first periodicity; performing, for a second set of downlink reference signals received via the downlink channel, a second set of measurements associated with a phase shift of the downlink channel, wherein the second set of downlink reference signals are received in accordance with a third periodicity that is less than the second periodicity; transmitting one or more feedback messages indicating the gain associated and the phase shift associated with the downlink channel; and communicating one or more messages with the network entity via the downlink channel, the uplink channel, or both, using a set of downlink communication parameters, a set of uplink communication parameters, or both, that are based at least in part on the gain, the phase shift, or both.

Aspect 2: The method of aspect 1, wherein transmitting the one or more feedback messages comprises: transmitting a first set of feedback messages indicating the gain in accordance with the second periodicity; and transmitting a second set of feedback messages indicating the phase shift in accordance with the third periodicity, wherein communicating the one or more messages is based at least in part on transmitting the first set of feedback messages in accordance with the second periodicity and transmitting the second set of feedback messages in accordance with the third periodicity.

Aspect 3: The method of any of aspects 1 through 2, further comprising: receiving, from the network entity, control signaling indicating the set of downlink communication parameters associated with the downlink channel, the set of uplink communication parameters associated with the uplink channel, or both, based at least in part on transmitting the one or more feedback messages indicating the gain and the phase shift associated with the downlink channel.

Aspect 4: The method of any of aspects 1 through 3, wherein the set of downlink communication parameters, the set of uplink communication parameters, or both, comprises a transmission power, a MCS, a precoder matrix, a rank, or any combination thereof.

Aspect 5: The method of any of aspects 1 through 4, further comprising: receiving a third set of downlink reference signals from the network entity via the downlink channel in accordance with a fourth periodicity that is greater than the second periodicity and the third periodicity; performing a channel estimation of the downlink channel based at least in part on receiving the third set of downlink reference signals; and transmitting one or more additional feedback messages indicating the channel estimation of the downlink channel, wherein the set of downlink communication parameters, the set of uplink communication parameters, or both, are based at least in part on the channel estimation of the downlink channel.

Aspect 6: The method of any of aspects 1 through 5, wherein the first periodicity, the second periodicity, the third periodicity, or any combination thereof, are based at least in part on one or more spatial characteristics associated with the one or more uplink reference signals.

Aspect 7: The method of aspect 6, wherein the one or more spatial characteristics associated with the one or more uplink reference signals comprise an AoA angle, a ZoA angle, an AoD angle, a ZoD angle, or any combination thereof.

Aspect 8: The method of any of aspects 1 through 7, further comprising: receiving control signaling indicating a configuration of the first periodicity, the second periodicity, the third periodicity, or any combination thereof.

Aspect 9: The method of any of aspects 1 through 8, wherein a value of the second periodicity is based at least in part on the gain associated with the downlink channel being within a threshold amount from a second gain associated with the uplink channel.

Aspect 10: The method of any of aspects 1 through 9, further comprising: obtaining a second gain and a second phase shift associated with the uplink channel based at least in part on the gain and the phase shift associated with the downlink channel.

Aspect 11: The method of aspect 10, wherein obtaining the second gain and the second phase shift comprises: identifying the second gain and the second phase shift based at least in part on a look-up table that associates gain values and phase shift values of the downlink channel with gain values and phase shift values of the uplink channel.

Aspect 12: A method for wireless communications by a network entity, comprising: performing, for a set of uplink reference signals received from a UE via an uplink channel between the UE and the network entity, a set of measurements associated with one or more spatial characteristics of the set of uplink reference signals, the uplink channel associated with a first set of frequency resources, wherein the set of uplink reference signals are received in accordance with a first periodicity; outputting, via a downlink channel between the UE and the network entity, a first set of downlink reference signals at a second periodicity, the downlink channel associated with a second set of frequency resources different from the first set of frequency resources, wherein the first set of downlink reference signals are output in accordance with a second periodicity that is less than the first periodicity; outputting, via the downlink channel, a second set of downlink reference signals at a third periodicity that is less than the second periodicity; obtaining one or more feedback messages indicating a gain of the downlink channel that is based at least in part on the first set of downlink reference signals and a phase shift of the downlink channel that is based at least in part on the second set of downlink reference signals; and communicating one or more messages with the network entity via the downlink channel, the uplink channel, or both, using a set of downlink communication parameters, a set of uplink communication parameters, or both, that are based at least in part on the gain, the phase shift, or both.

Aspect 13: The method of aspect 12, further comprising: performing a first channel estimation of the downlink channel and a second channel estimation of the uplink channel based at least in part on the set of measurements performed for the set of uplink reference signals, the gain of the downlink channel, and the phase shift of the downlink channel, wherein the set of downlink communication parameters and the set of uplink communication parameters are based at least in part on the first channel estimation of the downlink channel and the second channel estimation of the uplink channel.

Aspect 14: The method of any of aspects 12 through 13, wherein obtaining the one or more feedback messages comprises: obtaining a first set of feedback messages indicating the gain in accordance with the second periodicity; and obtaining a second set of feedback messages indicating the phase shift in accordance with the third periodicity, wherein communicating the one or more messages is based at least in part on obtaining the first set of feedback messages in accordance with the second periodicity and obtaining the second set of feedback messages in accordance with the third periodicity.

Aspect 15: The method of any of aspects 12 through 14, further comprising: outputting control signaling indicating the set of downlink communication parameters associated with the downlink channel, the set of uplink communication parameters associated with the uplink channel, or both, based at least in part on obtaining the one or more feedback messages indicating the gain and the phase shift associated with the downlink channel.

Aspect 16: The method of any of aspects 12 through 15, wherein the set of downlink communication parameters, the set of uplink communication parameters, or both, comprises a transmission power, a MCS, a precoder matrix, a rank, or any combination thereof.

Aspect 17: The method of any of aspects 12 through 16, further comprising: outputting a third set of downlink reference signals via the downlink channel in accordance with a fourth periodicity that is greater than the second periodicity and the third periodicity; and obtaining one or more additional feedback messages indicating a channel estimation of the downlink channel based at least in part on the third set of downlink reference signals, wherein the set of downlink communication parameters, the set of uplink communication parameters, or both, are based at least in part on the channel estimation of the downlink channel.

Aspect 18: The method of aspect 17, wherein the first periodicity, the second periodicity, the third periodicity, or any combination thereof based at least in part on the one or more spatial characteristics associated with the set of uplink reference signals, the one or more spatial characteristics comprise an AoA angle, a ZoA angle, an AoD angle, a ZoD angle, or any combination thereof.

Aspect 19: The method of any of aspects 12 through 18, further comprising: outputting control signaling indicating a configuration of the first periodicity, the second periodicity, the third periodicity, or any combination thereof.

Aspect 20: The method of any of aspects 12 through 19, wherein a value of the second periodicity is based at least in part on the gain associated with the downlink channel being within a threshold amount from a second gain associated with the uplink channel.

Aspect 21: A UE for wireless communications, comprising one or more memories storing processor-executable code, and one or more processors coupled with the one or more memories and individually or collectively operable to execute the code to cause the UE to perform a method of any of aspects 1 through 11.

Aspect 22: A UE for wireless communications, comprising at least one means for performing a method of any of aspects 1 through 11.

Aspect 23: A non-transitory computer-readable medium storing code for wireless communications, the code comprising instructions executable by one or more processors to perform a method of any of aspects 1 through 11.

Aspect 24: A network entity for wireless communications, comprising one or more memories storing processor-executable code, and one or more processors coupled with the one or more memories and individually or collectively operable to execute the code to cause the network entity to perform a method of any of aspects 12 through 20.

Aspect 25: A network entity for wireless communications, comprising at least one means for performing a method of any of aspects 12 through 20.

Aspect 26: A non-transitory computer-readable medium storing code for wireless communications, the code comprising instructions executable by one or more processors to perform a method of any of aspects 12 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, via an uplink channel between the UE and a network entity, one or more uplink reference signals at a first periodicity, the uplink channel associated with a first set of frequency resources;
perform, for a first set of downlink reference signals received via a downlink channel between the UE and the network entity, a first set of measurements associated with a gain of the downlink channel, the downlink channel associated with a second set of frequency resources different from the first set of frequency resources, wherein the first set of downlink reference signals are received in accordance with a second periodicity that is less than the first periodicity;
perform, for a second set of downlink reference signals received via the downlink channel, a second set of measurements associated with a phase shift of the downlink channel, wherein the second set of downlink reference signals are received in accordance with a third periodicity that is less than the second periodicity;
transmit one or more feedback messages indicating the gain associated and the phase shift associated with the downlink channel; and
communicate one or more messages with the network entity via the downlink channel, the uplink channel, or both, using a set of downlink communication parameters, a set of uplink communication parameters, or both, that are based at least in part on the gain, the phase shift, or both.

2. The UE of claim 1, wherein, to transmit the one or more feedback messages, the one or more processors are individually or collectively operable to execute the code to cause the UE to:
transmit a first set of feedback messages indicating the gain in accordance with the second periodicity; and
transmit a second set of feedback messages indicating the phase shift in accordance with the third periodicity, wherein communicating the one or more messages is based at least in part on transmitting the first set of feedback messages in accordance with the second periodicity and transmitting the second set of feedback messages in accordance with the third periodicity.

3. The UE of claim 1, wherein the one or more processors are individually or collectively further operable to execute the code to cause the UE to:
receive, from the network entity, control signaling indicating the set of downlink communication parameters associated with the downlink channel, the set of uplink communication parameters associated with the uplink channel, or both, based at least in part on transmitting the one or more feedback messages indicating the gain and the phase shift associated with the downlink channel.

4. The UE of claim 1, wherein the set of downlink communication parameters, the set of uplink communication parameters, or both, comprises a transmission power, a modulation and coding scheme, a precoder matrix, a rank, or any combination thereof.

5. The UE of claim 1, wherein the one or more processors are individually or collectively further operable to execute the code to cause the UE to:
receive a third set of downlink reference signals from the network entity via the downlink channel in accordance with a fourth periodicity that is greater than the second periodicity and the third periodicity;
perform a channel estimation of the downlink channel based at least in part on receiving the third set of downlink reference signals; and
transmit one or more additional feedback messages indicating the channel estimation of the downlink channel, wherein the set of downlink communication parameters, the set of uplink communication parameters, or both, are based at least in part on the channel estimation of the downlink channel.

6. The UE of claim 1, wherein the first periodicity, the second periodicity, the third periodicity, or any combination thereof, are based at least in part on one or more spatial characteristics associated with the one or more uplink reference signals.

7. The UE of claim 6, wherein the one or more spatial characteristics associated with the one or more uplink reference signals comprise an azimuth angle of arrival, a zenith angle of arrival, an azimuth angle of departure, a zenith angle of departure, or any combination thereof.

8. The UE of claim 1, wherein the one or more processors are individually or collectively further operable to execute the code to cause the UE to:
receive control signaling indicating a configuration of the first periodicity, the second periodicity, the third periodicity, or any combination thereof.

9. The UE of claim 1, wherein a value of the second periodicity is based at least in part on the gain associated with the downlink channel being within a threshold amount from a second gain associated with the uplink channel.

10. The UE of claim 1, wherein the one or more processors are individually or collectively further operable to execute the code to cause the UE to:
obtain a second gain and a second phase shift associated with the uplink channel based at least in part on the gain and the phase shift associated with the downlink channel.

11. The UE of claim 10, wherein, to obtain the second gain and the second phase shift, the one or more processors are individually or collectively operable to execute the code to cause the UE to:
identify the second gain and the second phase shift based at least in part on a look-up table that associates gain values and phase shift values of the downlink channel with gain values and phase shift values of the uplink channel.

12. A network entity, comprising:
one or more memories storing processor-executable code; and
one or more processors coupled with the one or more memories and individually or collectively operable to execute the code to cause the network entity to:
perform, for a set of uplink reference signals received from a user equipment (UE) via an uplink channel between the UE and the network entity, a set of measurements associated with one or more spatial characteristics of the set of uplink reference signals, the uplink channel associated with a first set of frequency resources, wherein the set of uplink reference signals are received in accordance with a first periodicity;
output, via a downlink channel between the UE and the network entity, a first set of downlink reference signals at a second periodicity, the downlink channel associated with a second set of frequency resources different from the first set of frequency resources, wherein the first set of downlink reference signals are output in accordance with a second periodicity that is less than the first periodicity;
output, via the downlink channel, a second set of downlink reference signals at a third periodicity that is less than the second periodicity;
obtain one or more feedback messages indicating a gain of the downlink channel that is based at least in part on the first set of downlink reference signals and a phase shift of the downlink channel that is based at least in part on the second set of downlink reference signals; and
communicate one or more messages with the network entity via the downlink channel, the uplink channel, or both, using a set of downlink communication parameters, a set of uplink communication parameters, or both, that are based at least in part on the gain, the phase shift, or both.

13. The network entity of claim 12, wherein the one or more processors are individually or collectively further operable to execute the code to cause the network entity to:
perform a first channel estimation of the downlink channel and a second channel estimation of the uplink channel based at least in part on the set of measurements performed for the set of uplink reference signals, the gain of the downlink channel, and the phase shift of the downlink channel, wherein the set of downlink communication parameters and the set of uplink communication parameters are based at least in part on the first channel estimation of the downlink channel and the second channel estimation of the uplink channel.

14. The network entity of claim 12, wherein, to obtain the one or more feedback messages, the one or more processors are individually or collectively operable to execute the code to cause the network entity to:
obtain a first set of feedback messages indicating the gain in accordance with the second periodicity; and
obtain a second set of feedback messages indicating the phase shift in accordance with the third periodicity, wherein communicating the one or more messages is based at least in part on obtaining the first set of feedback messages in accordance with the second periodicity and obtaining the second set of feedback messages in accordance with the third periodicity.

15. The network entity of claim 12, wherein the one or more processors are individually or collectively further operable to execute the code to cause the network entity to:
output control signaling indicating the set of downlink communication parameters associated with the downlink channel, the set of uplink communication parameters associated with the uplink channel, or both, based at least in part on obtaining the one or more feedback messages indicating the gain and the phase shift associated with the downlink channel.

16. The network entity of claim 12, wherein the one or more processors are individually or collectively further operable to execute the code to cause the network entity to:
output a third set of downlink reference signals via the downlink channel in accordance with a fourth periodicity that is greater than the second periodicity and the third periodicity; and
obtain one or more additional feedback messages indicating a channel estimation of the downlink channel based at least in part on the third set of downlink reference signals, wherein the set of downlink communication parameters, the set of uplink communication parameters, or both, are based at least in part on the channel estimation of the downlink channel.

17. The network entity of claim 16, wherein the first periodicity, the second periodicity, the third periodicity, or any combination thereof based at least in part on the one or more spatial characteristics associated with the set of uplink reference signals, and wherein the one or more spatial characteristics comprise an azimuth angle of arrival, a zenith angle of arrival, an azimuth angle of departure, a zenith angle of departure, or any combination thereof.

18. The network entity of claim 12, wherein the one or more processors are individually or collectively further operable to execute the code to cause the network entity to:
output control signaling indicating a configuration of the first periodicity, the second periodicity, the third periodicity, or any combination thereof.

19. The network entity of claim 12, wherein a value of the second periodicity is based at least in part on the gain associated with the downlink channel being within a threshold amount from a second gain associated with the uplink channel.

20. A method for wireless communications by a user equipment (UE), comprising:
transmitting, via an uplink channel between the UE and a network entity, one or more uplink reference signals at a first periodicity, the uplink channel associated with a first set of frequency resources;
performing, for a first set of downlink reference signals received via a downlink channel between the UE and the network entity, a first set of measurements associated with a gain of the downlink channel, the downlink channel associated with a second set of frequency resources different from the first set of frequency resources, wherein the first set of downlink reference signals are received in accordance with a second periodicity that is less than the first periodicity;
performing, for a second set of downlink reference signals received via the downlink channel, a second set of measurements associated with a phase shift of the downlink channel, wherein the second set of downlink reference signals are received in accordance with a third periodicity that is less than the second periodicity;
transmitting one or more feedback messages indicating the gain associated and the phase shift associated with the downlink channel; and
communicating one or more messages with the network entity via the downlink channel, the uplink channel, or both, using a set of downlink communication parameters, a set of uplink communication parameters, or both, that are based at least in part on the gain, the phase shift, or both.
